(19) United States
(12) Patent Application Publication
(10) Pub. No.: US 2015/0234992 A1
(43) Pub. Date: Aug. 20, 2015

(54) CLINICAL DECISION SUPPORT

(71) Applicant: KONINKLIJKE PHILIPS, Eindhoven (NL)

(72) Inventors: Sebastian Peter Michael Dries, Hamburg (DE); Jöerg Sabczynski, Hamburg (DE); Pavankumar Murli Dadlani Mahtani, Eindhoven (NL); Zarko Aleksovski, Eindhoven (NL)

(21) Appl. No.: 14/427,014

(22) PCT Filed: Sep. 10, 2013
(86) PCT No.: PCT/IB2013/058418

§ 371 Date: Mar. 10, 2015

Related U.S. Application Data
(60) Provisional application No. 61/699,419, filed on Sep. 11, 2012.

(30) Foreign Application Priority Data
Sep. 10, 2012 (EP) 12183654.8

(51) Int. Cl. G06F 19/00; G06N 5/04

(52) U.S. Cl. CPC G06F 19/345; G06N 5/045

(57) ABSTRACT

A clinical decision support system is disclosed, comprising pathway models (1) for at least a class of medical conditions defined in respect of a first dictionary and first semantics (13) matching a need of groups of users having different roles in respect of a clinical workflow. A pathway generator (5) generates a first representation (6) of a patient specific clinical pathway in accordance with the source model. A pathway translator (7) translates the first representation (6) of the patient specific clinical pathway into a corresponding second representation (8) of the patient specific clinical pathway in accordance with the target model, using the mapping model (3) to map elements of the first representation (6) into corresponding elements of the second representation (8).

### FIELD OF THE INVENTION

The invention relates to clinical decision support.

### BACKGROUND OF THE INVENTION

In many healthcare settings, communication between a healthcare professional and a patient plays an important role in the process of deciding on a particular treatment plan or the future part of a clinical pathway. This process is hampered when the patient or the healthcare professional do not understand each other.

Shared decision making is an evolving field of medicine in which decision aids are developed that help patients understand their choices and have the information they need to make decisions about their own health.

In the recent years there is a tendency to describe clinical pathways of patients using standardized coding systems, such as large medical ontologies, e.g. SNOMED-CT. This standardization has overall positive impact on the quality of healthcare, by creating the pathways using formal methods, or by translating the traditional textbook-form of clinical pathways into structured form.

Balser, M., et. al., “Protocure: supporting the development of medical protocols through formal methods”, Journal: Studies in health technology and informatics, 2004, pages 103-107, IOS Press, discloses a method of creating pathways using formal methods to replace traditional textbook form of clinical pathways.

US 2002/0184050 A1 discloses a computerized health evaluation system for joint patient and physician decision making concerning particular medical diseases and conditions. The system includes a computer system with a patient input module for patient input of patient data concerning the patient's lifestyle and preferences, a physician input module for physician input of physical and physiological data, and a database of the latest medical findings concerning the particular disease and condition. The computer system uses an algorithm for weighing the patient data and the physician data in view of the database and generating a report setting forth various treatment options. Based upon the report, the patient and physician will jointly decide on a treatment approach.

### SUMMARY OF THE INVENTION

It would be advantageous to have an improved clinical decision support. To better address this concern, a first aspect of the invention provides a system comprising a first pathway model for at least a class of medical conditions defined in respect of a first dictionary and first semantics matching a need of a first group of users;

a second pathway model corresponding to the first pathway model for at least the class of medical conditions defined in respect of a second dictionary and second semantics matching a need of a second group of users, wherein the second group of users have a different role in respect of a clinical workflow than the first group of users;

a mapping model defining a correspondence between the first pathway model and the second pathway model;

an identifying unit for identifying either the first pathway model or the second pathway model as a source model and identifying the other pathway model as a target model; a pathway generator for generating a first representation of a patient specific clinical pathway in accordance with the source model, based on information relating to a specific patient; and a pathway translator for translating the first representation of the patient specific clinical pathway into a corresponding second representation of the patient specific clinical pathway in accordance with the target model, using the mapping model to map elements of the first representation into corresponding elements of the second representation.

The system may assist in providing an improved dialogue between different groups of users that have different roles in the clinical workflow. For example, a dialogue between a patient and a healthcare professional may be improved using the techniques disclosed herein. The system may provide means to translate and retranslate between different perspectives on disease pathways for different groups of people, adapted to the needs of those different groups having different roles, and consequently different healthcare-related skills. These different groups may have different capabilities to comprehend the details of a representation of a disease pathway. The dictionary and semantics used in a representation of a disease pathway aimed at a particular group of users may be configured to match the needs, including the health literacy, of that group. For example, the system may provide means to translate and retranslate between patient and professional perspectives on disease pathways. This may be helpful to facilitate the communication between a patient and a healthcare professional. For example, risk communication on patients' preconditions and preferences in chronic condition management may be improved by translating the appropriate clinical pathway in a form that is suitable for consumption by the appropriate audience. A possible consequence of this is that a clinical pathway may be presented in different ways, comprising different information. For example, different details may be included in different representations of a pathway. For example, a representation of a pathway for a patient may contain educational material to educate the patient on the particular details of the condition and/or treatment options. The representation of the same pathway targeted at a healthcare professional, for example a medical doctor, may omit those educational details, but include details of the diagnosis that are of less relevance for the patient. Moreover, the terminology used in the representations may differ, because the terms used in the representation may be selected according to the needs, such as the healthcare literacy, of the particular type of user.

Healthcare professionals may be used to solving decision models that have been prepared for a class of diseases. They may solve these models for example mentally, by using information management, or by clinical decision support. However, the details of the models and how they lead to a conclusion may not be clear to a patient. Consequently, the meanings of certain questions, the importance or irrelevance of history items, findings and preferences may be doubtful for the patient. A translation of the information relating to the patient pathway while addressing the difference in medical science literacy between the care givers and the cared for may be used to validate the care professional's solution of the decision model by translating it for the patient, allow the patient to assess and potentially modify it, and translate it back.

The system may comprise a first change unit for making a change to the patient specific clinical pathway by modifying the first representation of the patient specific clinical pathway, to obtain a modified first representation. The pathway translator may be arranged for performing the translating based on the modified first representation. This allows the user to modify the patient specific pathway based on the first representation, while the modifications may be translated into the second representation, allowing another user to evaluate the modifications using the second representation.

The system may comprise a second change unit for making a change to the patient specific clinical pathway by modifying the second representation of the patient specific clinical pathway, to obtain a modified second representation. The pathway translator may be arranged for translating the modified second representation of the patient specific clinical pathway according to the target model back into a corresponding modified first representation of the patient specific clinical pathway according to the source model, using the mapping model to map at least a modified element of the modified second representation into a corresponding element of the corresponding modified first representation. This allows the representation of the clinical pathway to be generated according to the source model, modifications to be made in the second representation according to the target model, wherein the modifications are translated back into a representation according to the source model. This allows a person with a literacy that does not correspond to the first model, to make modifications to a clinical pathway based on literacy corresponding to a second model.

The change may relate to an individualization of the specific clinical patient pathway, reflecting a precondition or a preference. This allows to personalize a clinical patient pathway using the appropriate representation.

The first group of users may comprise or consist of healthcare consumers, and the need of the healthcare consumers may comprise matching a healthcare consumer's health literacy. In this case, the first dictionary and first semantics may be configured to match a healthcare consumer's health literacy.

The second group of users may comprise or consist of healthcare professionals, and the need of the healthcare professionals may comprise matching a healthcare professional's health literacy. In this case, the second dictionary and second semantics may be configured to match a healthcare professional's health literacy.

The first pathway model may define at least one of: use of everyday language, use of simplified sentences, use of visuals to explain technical terms, a visualization of a location and/or an extent of a lesion, a visual calendar with appointments, omitting technical details of a diagnosis or treatment, an explanation of a foreseen or achieved effect or side-effect of a treatment. A first pathway model defined in such a way may allow creation of a representation of a clinical pathway that is particularly understandable for a patient. The second pathway model may define at least one of: use of medical language, use of complex sentences, use of technical terms, including available technical details of a diagnosis or treatment that is relevant for the healthcare professional, omitting explanations of technical terms. A second pathway model defined in such a way may allow creation of a representation of a clinical pathway that is particularly understandable and/or efficient for a healthcare professional.

The system may comprise a patient user interface for presenting the representation of the patient specific clinical pathway according to the first pathway model to a patient user. Such a patient user interface may allow the patient to explore the first representation.

The system may comprise a healthcare professional user interface for presenting the representation of the patient specific clinical pathway according to the second pathway model to a healthcare professional user. Such a healthcare professional user interface may allow the healthcare professional to explore the second representation.

The patient user interface or the healthcare professional user interface may be arranged for receiving from the respective user an indication of a change to the patient specific clinical pathway in terms of the respective representation. This allows the respective user to not only explore the representation, but also indicate changes using a language the user is familiar with.

The pathway generator may be arranged for receiving the information relating to the specific patient at least partly by means of manual entry and/or from an electronic medical record. This allows the patient information to be provided, and the first representation of the patient specific clinical pathway to be generated in an efficient way.

The pathway generator may be arranged for performing the generating of the patient specific clinical pathway in dependence on healthcare provider specific content, a standard operating procedure, and/or aggregate consented evidence of how to approach the medical condition and its course of care. This allows to generate the patient specific clinical pathway in an efficient way. Alternatively, this may allow to improve the quality of the patient specific clinical pathway.

The system may comprise an uncertainty indicator for generating an indication of an uncertainty regarding a correspondence between the first representation and the second representation. This allows the users to be alerted of any imperfections in the translation.

In another aspect, the invention provides a computer system comprising a clinical decision support system as set forth herein.

In another aspect, the invention provides a clinical decision support method, comprising

identifying either a first pathway model or a second pathway model as a source model and identifying the other pathway model as a target model, wherein the first pathway model for at least a class of medical conditions is defined in respect of a first dictionary and first semantics matching a need of a first group of users, and the second pathway model corresponding to the first pathway model for at least the class of medical conditions is defined in respect of a second dictionary and second semantics matching a need of a second group of users, wherein the second group of users have a different role in respect of a clinical workflow than the first group of users, and wherein a mapping model defines a correspondence between the first pathway model and the second pathway model;

generating a first representation of a patient specific clinical pathway in accordance with the source model, based on information relating to a specific patient; and

translating the first representation of the patient specific clinical pathway into a corresponding second representation of the patient specific clinical pathway in accordance with the target model, using the mapping model to map elements of the first representation into corresponding elements of the second representation.

In another aspect, the invention provides a computer program product comprising instructions for causing a processor system to perform a method set forth herein.

It will be appreciated by those skilled in the art that two or more of the above-mentioned features, embodiments, implementations, and/or aspects of the invention may be combined in any way deemed useful.

Modifications and variations of the computer system, the decision support system, the method, and/or the computer program product, which correspond to the described modifications and variations of the system, can be carried out by a person skilled in the art on the basis of the present description.

### BRIEF DESCRIPTION OF THE DRAWINGS

These and other aspects of the invention are apparent from and will be elucidated hereinafter with reference to the drawings.

FIG. 1 is a block diagram of a clinical support system.

FIG. 2 is a flowchart of a clinical decision support method.

### DETAILED DESCRIPTION OF EMBODIMENTS

Hereinafter, aspects of the invention will be described in further detail. However, details described herein only serve as examples. They are not intended to limit the scope of the invention.

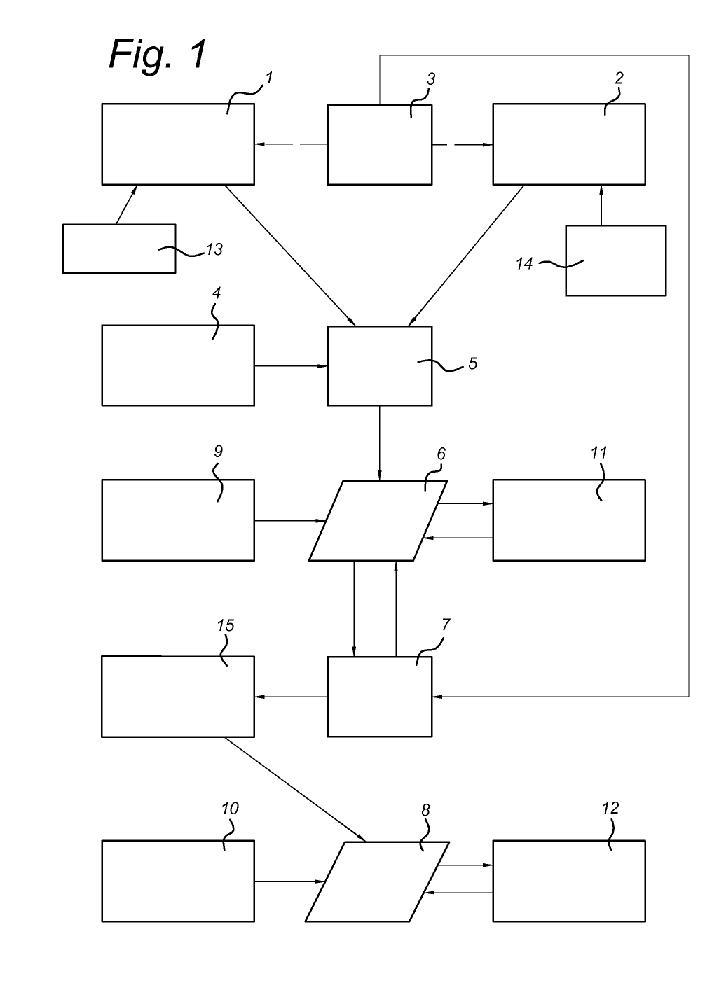

FIG. 1 shows a block diagram of a clinical decision support system. The system may be implemented in a distributed computer system, for example on a server, ‘in the cloud’, on a web server, or using a client-server architecture. Alternatively, the system may be implemented on a standalone workstation. Some parts of the system may be implemented by means of computer program instructions and/or a suitable data structure stored on a media carrier and accessible by the processor of a computer.

The system may be part of, or connected to, a healthcare information system, such as a hospital information system, or a database comprising one or more personal health records. From such an information system, the clinical decision support system may retrieve patient specific data. Moreover, general models and/or guidelines may be stored in such a system. Alternatively, such data may be stored in any kind of file system or database.

The system may comprise one or more pathway models. A pathway model may provide a specification of information elements to be included in a representation of a patient specific clinical pathway relevant to at least a class of medical conditions, based on a set of rules, and usually based on patient specific clinical information. Moreover, the pathway model may specify the terms to be used in the representation. For example, the pathway model is associated with an ontology that defines the terms to be used to express particular semantics. The pathway model may also define the semantics to be used for the terms in the representation. The pathway model may define what information elements should be present in a patient pathway, how different elements should be interrelated, what kinds of information need to be included, and/or what kinds of information may be omitted.

Different groups of users, in particular different groups of users that have different roles in the healthcare organization, may have different set of skills when it comes to interpreting the representation. Consequently, the pathway model may be adapted to the skills of a particular group of users, by using terms and semantics that the users of a group can be expected to comprehend and/or appreciate. Examples of different groups of users are: physicians, nurses, patients, relatives of patients. To specify it further, it is possible to define different groups of users by specialty of the user, for example a group of oncologists may be distinguished from a group of orthopedists.

More specifically, the system may comprise a first pathway model 1 defining how to construct patient pathways in respect of a first dictionary and first semantics 13 matching a need of a first group of users. In particular, the first dictionary and first semantics 13 may be arranged to match a health literacy of the first group of users.

A second pathway model 2, may define how to construct patient pathways in respect of a second dictionary and second semantics 14 matching a need of a second group of users. For example, the second pathway model may match a health literacy of the second group of users. The second pathway model 2 may correspond to the first pathway model 1 for at least the above-mentioned class of medical conditions. The first pathway model 1 and the second pathway model 2 may correspond to each other in that they model the same kinds of clinical pathway for the same medical conditions. Consequently, they may allow to generate different representations for the same clinical pathway.

In a specific example, the first group of users are patients, and the second group of users are healthcare professionals.

The system may comprise a mapping model 3 defining a correspondence between the first pathway model and the second pathway model. This correspondence may associate elements of the first pathway model 1 with elements of the second pathway model 2. For example, terms used in the first pathway model 1 may be associated with corresponding terms used in the second pathway model.

For example, the mapping model 3 may be associated with a third pathway model that defines a machine readable format of a clinical pathway. The mapping model 3 may associate an element of the first pathway model with an element of the second pathway model by associating both elements with the same corresponding element of the third pathway model. However, the mapping model 3 may also associate the elements of the first pathway model 1 directly with the elements of the second pathway model 2.

The system may comprise an identifying unit 4 arranged for identifying either the first pathway model 1 or the second pathway model 2 as a source model and identifying the other pathway model as a target model. The identifying unit 4 may be implemented implicitly by hard-coding either pathway model as source model and the other as target model. Alternatively, the identifying unit 4 may be implemented as a configurable option or as a selector that can make the choice based on a predetermined set of conditions.

The system may comprise a pathway generator 5 arranged for generating a first representation 6 of a patient specific clinical pathway in accordance with the source model, based on information relating to a specific patient. The pathway generator 5 may be arranged for collecting appropriate information from an information system, and apply applicable rules and/or elements of the source model to generate and combine the individual elements of the first representation 6 of the patient specific pathway.

The system may comprise a pathway translator 7 arranged for translating the first representation 6 of the patient specific clinical pathway into a corresponding second representation 8 of the patient specific clinical pathway. This second representation 8 of the patient specific clinical pathway may be determined in accordance with the target model. However, the clinical pathway represented by the first representation 6 and the second representation 8 is essentially the same, and may relate to the same pathway of the same patient. The pathway translator 7 may be arranged for using the mapping model 3 to map elements of the first representation 6 into corresponding elements of the second representation 8.

The system may comprise a first change unit 9 arranged for making a change to the patient specific clinical pathway. To this end, the first change unit 9 may be arranged for modifying the first representation 6 of the patient specific clinical pathway, to obtain a modified first representation. The modification may involve making a choice between different options that are available in view of the available patient-specific clinical information and/or general clinical guidelines or rules.

The pathway translator 7 may be arranged for generating the translation based on the modified first representation. The system may be arranged for making the change to the first representation 6 before translating the resulting modified representation into the second representation 8. Alternatively, the pathway translator 7 may be arranged for translating both the first representation 6 and the modified first representation. This way, two versions of the second representation 8 according to the target model 2 may be generated. For example, the user may be enabled to control operation of the first change unit 9 and the pathway translator 7, to make changes and translations according to the user's need.

The system may comprise a second change unit 10 arranged for making a change to the patient specific clinical pathway by modifying the second representation 8 of the patient specific clinical pathway, to obtain a modified second representation. The pathway translator 7 may be arranged for translating the modified second representation of the patient specific clinical pathway according to the target model back into a corresponding modified first representation of the patient specific clinical pathway according to the source model, using the mapping model 3 to map at least a modified element of the modified second representation into a corresponding element of the corresponding modified first representation. Similar to the operation of the first change unit 9, the operation of the second change unit 10 may be automatic or based on user input. Moreover, the triggering of the pathway translator 7 to translate the modified second representation back into a modified first representation using the source pathway model may be performed automatically or manually.

The change to the pathway may relate to an individualization of the specific clinical patient pathway, reflecting a precondition or a preference of a user such as a patient or a healthcare professional.

The first pathway model 1 may define at least one of: use of everyday language, use of simplified sentences, use of visuals to explain technical terms, a visualization of a location and/or an extent of a lesion, a visual calendar with appointments, omitting technical details of a diagnosis or treatment, an explanation of a foreseen or achieved effect or side-effect of a treatment.

The second pathway model 2 may define at least one of: use of medical language, use of complex sentences, use of technical terms, including available technical details of a diagnosis or treatment that is relevant for the healthcare professional, omitting explanations of technical terms.

It will be understood that either the first pathway model or the second pathway model is used as the source model, and the other pathway model is used as the target model. Consequently, either the first pathway model is the source model and the second pathway model is the target model, or the second pathway model is the source model and the first pathway model is the target model.

The system may comprise a patient user interface 11 arranged for presenting the representation of the patient specific clinical pathway according to the first pathway model to a patient user.

The system may comprise a healthcare professional user interface 12 for presenting the representation of the patient specific clinical pathway according to the second pathway model to a healthcare professional user.

The patient user interface 11 or healthcare professional user interface 12 may be arranged for receiving from the respective user an indication of a change to the patient specific clinical pathway in terms of the respective representation. For example, an option may be indicated by means of a user interface element such as a radio button or a drop-down box. Moreover, the user may be enabled to edit the representation graphically or by means of text editing or by means of a speech interface.

The pathway generator 5 may be arranged for receiving the information relating to the specific patient at least partly by means of manual entry and/or from an electronic medical record.

The pathway generator 5 may be arranged for generating the first representation of the pathway in dependence on healthcare provider specific content, a standard operating procedure, and/or aggregate consented evidence of how to approach the medical condition and its course of care.

The system may comprise an uncertainty indicator 15 for generating an indication of an uncertainty regarding a correspondence between the first representation and the second representation. Such an uncertainty may be detected by the pathway translator 7 during the translation. Moreover, the mapping model 3 may comprise an indication of an uncertainty associated with a mapping between an element of the first pathway model 1 and an element of the second pathway model 2.

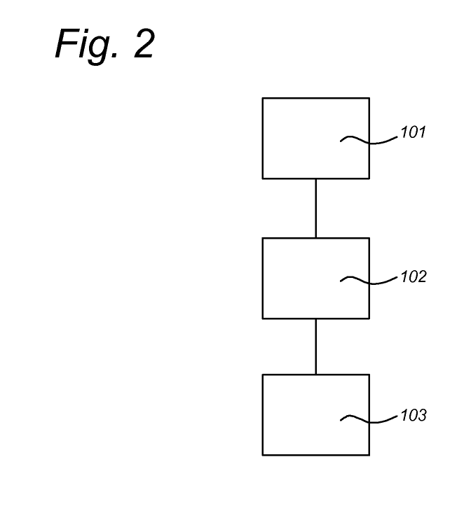

FIG. 2 illustrates aspects of a clinical decision support method by means of a flowchart. The method comprises in step 101 identifying either a first pathway model or a second pathway model as a source model and identifying the other pathway model as a target model, wherein the first pathway model for at least a class of medical conditions is defined in respect of a first dictionary and first semantics matching, for example, a healthcare consumer's health literacy, and the second pathway model corresponding to the first pathway model for at least the class of medical conditions is defined in respect of a second dictionary and second semantics matching, for example, a healthcare professional's health literacy, and wherein a mapping model defines a correspondence between the first pathway model and the second pathway model. The method further comprises generating in step 102 a first representation of a patient specific clinical pathway in accordance with the source model, based on information relating to a specific patient. The method further comprises translating in step 103 the first representation of the patient specific clinical pathway into a corresponding second representation of the patient specific clinical pathway in accordance with the target model, using the mapping model to map elements of the first representation into corresponding elements of the second representation.

The method may be extended and/or modified based on the description of the functionality of the system. The method may be implemented by means of a computer program that causes a computer system to perform the method.

Existing decision aids are mainly informational and do not adapt themselves to the individual patient's preconditions and preferences. The patient has to read generic information and try to apply the general information to the patient's specific case. The answer to questions along the personalized patient pathway—“how does evidence relate to me, and how am I predisposed to have my condition follow alternative paths?” is thus to a large extent dependent on the patient's interpretation of the information. Now when the patient seeks clarification—of questions that remain on applicability and options of the disease pathway for his care—in consultation with the healthcare professional, the discussion and answers should relate to the ontology and semantics understood by the patient. However, the clinician is used to discuss and answer based on the professional ontology and semantics including medical jargon. This asymmetry in health literacy creates confusion between patients and clinicians, and may result in asking each other comprehension-related questions repetitively. Translation and re-translation of the clinical pathway between patient and professional versions may be used to enhance a medical shared decision-making process by medical informatics and human-computer interaction methods.

Two corresponding care pathway models for the particular disease entity may be employed that use ontologies and semantics matching patient and professional societies' understanding of healthcare consumer and provider health literacy, respectively. The patient may be provided with tools to individualize the comprehensive patient pathway model to his individual foreseen pathway, reflecting his preconditions and preferences, using the pathway model for the patient. Based on the correspondence of the patient and the professional pathway models, the systems and methods disclosed herein may generate a professional version of the individual pathway for presentation to and potentially modification by the health professional (e.g. during patient consultation). Afterwards the systems and methods disclosed herein may translate the (potentially modified) professional version back into a patient version of the individual pathway for verification by the patient.

The individual pathway relating to a single patient may essentially comprise an instantiation of the general clinical pathways (which are commonly disease-centric). In order to translate this instantiation between the patient and professional pathway models, a correspondence between these models may be created. It is possible to create this correspondence automatically or semi-automatically in the form of mapping between pairs of elements from the two models. This mapping then enables an effective way to translate the patient specific instantiated pathway between the two models.

For parameterization of the pathway versions, alternatively an interactive all manual data entry or a semi-automatic approach that uses patient data on file, e.g. within an Electronic Medical Record, may be used to populate the pathway. The pathway models may be populated by combining healthcare provider specific content (institutional standard operating procedures) that aggregate consented evidence of how to approach a certain medical condition and its course of care with individual patient data. The aggregation may be established by chances of the patient matching the populations from which the pathway was designed (on demographics), and by chances of the patient to develop his condition among alternative paths (using statistics such as a sensitivity analysis of pathway options based on the input variations that the patient data has).

Depending on the workflow of the healthcare institution, either a patient version or a professional version of the pathway may be rendered first. Alternatively, both versions may be generated at the same time. The patient version may be used by the patient to enter or interact with his previous history and preferences and potentially make adjustments. After that the patient version may be translated into a professional version for interaction with the care provider e.g. during a consultation, and then translated back for the patient to see if all his needs are taken care of and any issues have been settled towards the decision. In case the professional version is used first, there may be an initial parameterization and review option of the individual patient pathway by the care provider, after which the potentially modified professional version of the pathway is translated into a patient version.

Optionally, the individual pathway may be translated from patient version into professional version and back from professional version into patient version without modifications on the professional side, to validate the accuracy of the translation method. It is also possible to retranslate from professional version to patient version after modifications that the clinician made based on the consultation with the patient, to enable the clinician to get feedback from the patient as to whether the patient agrees that this was the settled consultation result. If there are differences in the retranslation these can be used for quality management of the consultation process and/or to adapt the decision accordingly.

Moreover, similarity measures may be used to calculate, indicate, and/or visualize a degree of uncertainty in choices or agreement between the different translation steps or just the points in the pathway where further clarification should be sought.

The translation between the professional representation and patient representation of the pathways may be done automatically using either one or a combination of two approaches: lexical and topological. However, this is not a limitation. Other techniques may be used in addition or alternatively. Lexical methods for mapping elements are known in the field of NLP (Natural Language Processing), and such methods may be used to detect a similarity between the words used to name an element, as well as the description of the elements in the model. Topological methods are also known as structural matching methods in the field of ontology matching. Topological methods may be used to detect a similarity between individual elements using the overall topology of the two models. Topological methods may be used to prevent that elements which are named similarly but have a very different meaning (like hypothermia and hyperthermia, for example) are mistakenly mapped to one another by the lexical methods. The topological matching can be used for consistency checking on the lexically created mapping.

Lexical matching may be used to compare each pair of elements between the two models, calculate a similarity between each pair, and then establish mapping between the pairs of elements for which the similarity is greater than a predetermined acceptability threshold. Two elements may be compared by first normalizing the words in their names and/or descriptions (in English one such way to normalize is called stemming), and then lexical similarity may be calculated between these normalized words from the names of the two elements. A well-known lexical similarity measure is the Levenstein string distance measure. After similarity has been calculated between each pair of elements, those pairs with similarity greater than a previously established threshold may be concluded as mappings between the models.

If inaccuracies are observed in this automatic translation then it may be assisted through manual monitoring and correcting the translation process. More advanced systems may also be arranged to detect regularities in the correction process and adapt the translation itself.

Other mapping techniques may also be used. For example, a manually drafted mapping between elements of a first pathway model 1 and a second pathway model 2 may be employed. This way, the medical and other expert knowledge about correspondence between elements of the two models may be captured in the mapping model 3.

It will be appreciated that the invention also applies to computer programs, particularly computer programs on or in a carrier, adapted to put the invention into practice. The program may be in the form of a source code, an object code, a code intermediate source and an object code such as in a partially compiled form, or in any other form suitable for use in the implementation of the method according to the invention. It will also be appreciated that such a program may have many different architectural designs. For example, a program code implementing the functionality of the method or system according to the invention may be sub-divided into one or more sub-routines. Many different ways of distributing the functionality among these sub-routines will be apparent to the skilled person. The sub-routines may be stored together in one executable file to form a self-contained program. Such an executable file may comprise computer-executable instructions, for example, processor instructions and/or interpreter instructions (e.g. Java interpreter instructions). Alternatively, one or more or all of the sub-routines may be stored in at least one external library file and linked with a main program either statically or dynamically, e.g. at run-time. The main program contains at least one call to at least one of the sub-routines. The sub-routines may also comprise calls to each other. An embodiment relating to a computer program product comprises computer-executable instructions corresponding to each processing step of at least one of the methods set forth herein. These instructions may be sub-divided into sub-routines and/or stored in one or more files that may be linked statically or dynamically. Another embodiment relating to a computer program product comprises computer-executable instructions corresponding to each means of at least one of the systems and/or products set forth herein. These instructions may be sub-divided into sub-routines and/or stored in one or more files that may be linked statically or dynamically.

The carrier of a computer program may be any entity or device capable of carrying the program. For example, the carrier may include a storage medium, such as a ROM, for example, a CD ROM or a semiconductor ROM, or a magnetic recording medium, for example, a flash drive or a hard disk. Furthermore, the carrier may be a transmissible carrier such as an electric or optical signal, which may be conveyed via electric or optical cable or by radio or other means. When the program is embodied in such a signal, the carrier may be constituted by such a cable or other device or means. Alternatively, the carrier may be an integrated circuit in which the program is embedded, the integrated circuit being adapted to perform, or used in the performance of, the relevant method.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A clinical decision support system, comprising
a first pathway model for at least a class of medical conditions defined in respect of a first dictionary and first semantics matching a need of a first group of users;
a second pathway model corresponding to the first pathway model for at least the class of medical conditions defined in respect of a second dictionary and second semantics matching a need of a second group of users, wherein the second group of users have a different role in respect of a clinical workflow than the first group of users;
a mapping model defining a correspondence between the first pathway model and the second pathway model;
an identifying unit for identifying either the first pathway model or the second pathway model as a source model and identifying the other pathway model as a target model;
a pathway generator for generating a first representation of a patient specific clinical pathway in accordance with the source model, based on information relating to a specific patient;
a pathway translator for translating the first representation of the patient specific clinical pathway into a corresponding second representation of the patient specific clinical pathway in accordance with the target model, using the mapping model to map elements of the first representation into corresponding elements of the second representation.

2. The system according to claim 1, further comprising
a first change unit for making a change to the patient specific clinical pathway by modifying the first representation of the patient specific clinical pathway, to obtain a modified first representation;
wherein the pathway translator is arranged for performing the translating based on the modified first representation.

3. The system according to claim 1, further comprising
a second change unit for making a change to the patient specific clinical pathway by modifying the second representation of the patient specific clinical pathway, to obtain a modified second representation;
wherein the pathway translator is arranged for translating the modified second representation of the patient specific clinical pathway according to the target model back into a corresponding modified first representation of the patient specific clinical pathway according to the source model, using the mapping model to map at least a modified element of the modified second representation into a corresponding element of the corresponding modified first representation.

4. The system according to claim 2, wherein the change relates to an individualization of the specific clinical patient pathway, reflecting a precondition or a preference.

5. The system according to claim 1,
wherein the first group of users comprises healthcare consumers, and the need of the healthcare consumers comprises matching a healthcare consumer's health literacy; and
wherein the second group of users comprises healthcare professionals, and the need of the healthcare professionals comprises matching a healthcare professional's health literacy.

6. The system according to claim 1, wherein the first pathway model defines at least one of: use of everyday language, use of simplified sentences, use of visuals to explain technical terms, a visualization of a location and/or an extent of a lesion, a visual calendar with appointments, omitting technical details of a diagnosis or treatment, an explanation of a foreseen or achieved effect or side-effect of a treatment.

7. The system according to claim 1, wherein the second pathway model defines at least one of: use of medical language, use of complex sentences, use of technical terms, including available technical details of a diagnosis or treatment that is relevant for the healthcare professional, omitting explanations of technical terms.

8. The system according to claim 1, wherein the first group of users is patients, the system comprising a patient user interface for presenting the representation of the patient specific clinical pathway according to the first pathway model to a patient user.

9. The system according to claim 1, wherein the second group of users is healthcare professionals, the system comprising a healthcare professional user interface for presenting the representation of the patient specific clinical pathway according to the second pathway model to a healthcare professional user.

10. The system according to claim wherein the patient user interface or healthcare professional user interface is arranged for receiving from the respective user an indication of a change to the patient specific clinical pathway in terms of the respective representation.

11. The system according to claim 1, wherein the pathway generator is arranged for receiving the information relating to the specific patient at least partly by means of manual entry and/or from an electronic medical record.

12. The system according to claim 1, further comprising an uncertainty indicator for generating an indication of an uncertainty regarding a correspondence between the first representation and the second representation.

13. A computer system comprising the system according to claim 1.

14. A clinical decision support method, comprising
identifying either a first pathway model or a second pathway model as a source model and identifying the other pathway model as a target model, wherein the first pathway model for at least a class of medical conditions is defined in respect of a first dictionary and first semantics matching a need of a first group of users, and the second pathway model corresponding to the first pathway model for at least the class of medical conditions is defined in respect of a second dictionary and second semantics matching a need of a second group of users, wherein the second group of users have a different role in respect of a clinical workflow than the first group of users, and wherein a mapping model defines a correspondence between the first pathway model and the second pathway model;
generating a first representation of a patient specific clinical pathway in accordance with the source model, based on information relating to a specific patient; and
translating the first representation of the patient specific clinical pathway into a corresponding second representation of the patient specific clinical pathway in accordance with the target model, using the mapping model to map elements of the first representation into corresponding elements of the second representation.

15. A computer program product comprising instructions for causing a processor system to perform the method according to claim 14.
